(19) United States
(12) Patent Application Publication
(10) Pub. No.: US 2003/0158938 A1
(43) Pub. Date: Aug. 21, 2003

(54) Methods of performing mobile IP registration in a wireless communication system

(76) Inventors: Ravi Madhav K. Adatrao, Palatine, IL (US); Andrew J. Harris, Columbia, MD (US); Hania A. Yassin, West Chicago, IL (US); James E. Eastwood, Bellingham, WA (US)

Correspondence Address: MOTOROLA, INC., 1303 EAST ALGONQUIN ROAD, IL01/3RD, SCHAUMBURG, IL, 60196

(21) Appl. No.: 10/077,463

(22) Filed: Feb. 15, 2002

(51) Int. Cl. G06F 15/16; G06F 15/173

(52) U.S. Cl. 709/225; 709/230

(57) ABSTRACT

A mobile IP registration solution for mobile nodes (108-111) of a wireless communication system (100) eliminates the need for sending (208) solicitation messages or receiving (210) advertisement messages from foreign agents (118). A mobile node receives an IP address of a foreign agent from a control message upon roaming into a new site or zone and attempting (304) to acquire a channel. Substantially immediately upon acquiring (306) a channel, the mobile node determines (308) whether to send a proxy MIP advertisement. If not, the mobile node retrieves (310) the foreign agent IP address and forwards (312) the foreign agent IP address to a processing element (e.g., layer 3 processing element). If a proxy MIP advertisement will be sent, the mobile node retrieves (314) the foreign agent IP address and a static capabilities list associated with the foreign agent, constructs (316) a proxy MIP advertisement and forwards (318) the proxy MIP advertisement to a processing element (e.g., layer 3 processing element). Upon receiving the foreign agent IP address or proxy MIP advertisement, the processing element constructs (320) a mobile IP registration request using the foreign agent IP address. The registration request is sent (322) to a home agent (130), along with a care of address, such that the home agent may tunnel packets targeted to the mobile nodes via the care of address while they are at the visited site or network.

### FIELD OF THE INVENTION

This invention relates generally to wireless communication systems, and, more particularly, to methods of performing Mobile IP registration in a wireless communication system.

### BACKGROUND OF THE INVENTION

Many communication systems use Internet Protocol (IP) to transport packet data representative of voice, video, data or control traffic between endpoints (or “hosts” in IP terminology). In such systems, the data is divided into IP packets called datagrams that include addressing information (e.g., source and destination addresses) that enables various routers forming an IP network to route the packets to the specified destination. The destination address may comprise a unicast address identifying a particular host. The unicast address is typically determined, at least in part, by the host's point of attachment to the network. The unicast address associated with the host's nominal point of attachment to the network is often termed its “home” IP address.

A problem that arises is that some hosts, known as mobile nodes, may periodically change their point of attachment to the IP network. For example, a laptop computer normally associated with a first site may be connected to the internet at a second, remote site. Further, wireless devices, such as mobile or portable radio units or mobile phones, are never physically connected to the IP network but may wirelessly “attach” (i.e., communicate via radio frequency (RF) resources) with IP infrastructure devices as they move from site to site or even between different communication networks that use IP. A protocol known as Mobile Internet Protocol (or “mobile IP”) accommodates mobility of the mobile nodes, that is to maintain IP connectivity for the mobile nodes as they move to different sites or networks. Presently, there are two different versions of mobile IP, version 4 (“MIPv4,” or “standard mobile IP”) and version 6 (“MIPv6”).

Standard mobile IP relies upon a mobile node recognizing when it is at a foreign site and, in such case, to perform a mobile IP registration process. Generally, the registration process requires the mobile node to identify a “foreign agent” associated with the visited network and receive a temporary forwarding address (known as a “care of” address) where it can receive packets while it is attached to the visited network. The foreign agent relays the care of address to a “home agent” associated with the mobile node's home network, thereby causing the home agent to know where to send packets destined for the mobile node when it is not on the home network. Thereafter, packets addressed to the mobile node's home address are intercepted by the home agent and tunneled to the foreign agent using the care of address. The foreign agent de-tunnels the packets (i.e., strips off the care of address) before routing the packets to the mobile node. In such manner, the mobile node is always addressable by its “home” IP unicast address, either directly when it is at its home address, or indirectly via tunneling from the home agent when it is at a visited network.

Heretofore, the standard mobile IP registration process has relied upon mobile node(s) receiving an “advertisement” message from the foreign agent of the visited network to enable the mobile node to identify its foreign agent. The advertisement message identifies the IP address of the foreign agent as well as available service(s) or capabilities associated with the foreign agent. The advertisement messages may be sent at periodic advertisement intervals and/or in response to “solicitation” messages from the mobile node(s).

A problem that arises is that excessive time delays can and do result from solicitation/advertisement transactions between foreign agents and wireless mobile nodes.

Generally, customers demand relatively seamless IP connectivity of wireless mobile nodes as they move to different sites or networks. To achieve such seamless mobility, it would be desirable to perform mobile IP registration in times on the order of tenths of seconds. However, the typical solicitation/advertisement message transaction takes about 1-1½ seconds, causing unacceptable delays in handoff or set up times. In the case of unsolicited advertisements, delays could be reduced by reducing the length of the advertisement intervals, but this would result in multiple advertisements propagating through the network, thereby consuming excessive bandwidth and adversely affecting handoff times and quality of service of the network.

Accordingly, a need has arisen for methods for a mobile node to perform mobile IP registration in a wireless communication system in a manner that does not require the mobile node to exchange solicitation/advertisement messages with a foreign agent. Advantageously, the methods will allow for seamless mobility of the mobile node as it travels to foreign sites or networks. The present invention is directed to satisfying these needs.

### BRIEF DESCRIPTION OF THE DRAWINGS

The foregoing and other advantages of the invention will become apparent upon reading the following detailed description and upon reference to the drawings in which:

FIG. 1 is a block diagram showing a wireless communication system including mobile nodes at various sites operable to perform mobile IP registration according to the present invention;

FIG. 2 is a flowchart showing steps performed by mobile nodes to perform mobile IP registration according to the prior art; and

FIG. 3 is a flowchart showing steps performed by mobile nodes to perform mobile IP registration with or without proxy mobile IP advertisements according to the present invention.

### DESCRIPTION OF PREFERRED EMBODIMENTS

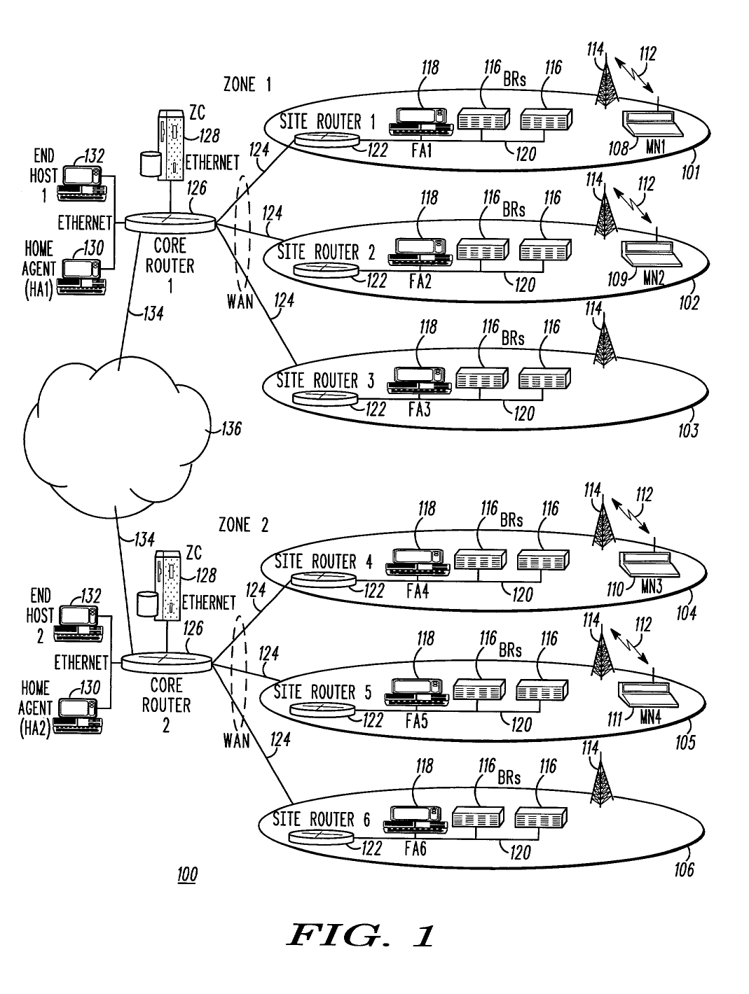

FIG. 1 shows by way of example and not limitation, a wireless, packet-based communication system 100 comprising a plurality of sites 101-106 organized into zones (“Zone 1” and “Zone 2”). Distributed among the sites 101-106 are a plurality of mobile nodes 108-111 (denoted MN1 through MN4). As shown, mobile nodes MN1, MN2 are situated at sites 101, 102 (Zone 1), whereas mobile nodes MN3, MN4 are at sites 104, 105 (Zone 2). For purposes of the present example, it is presumed that Zone 1 is the “home” zone of all of the mobile nodes.

The mobile nodes 108-111 comprise wireless devices which may include, but are not limited to, laptop computers, wireless mobile or portable two-way radios, cellular radio/telephones, personal digital assistants (PDAs) and the like having varying capacities to transmit and receive information, such as voice, video, or data traffic (“payload information”) or control signaling (“control information”) associated with communication service(s). The communication services may comprise, for example, telephone service, dispatch service, electronic mail, paging service, electronic commerce, location service and/or packet data service. In one embodiment, the mobile devices 108-111 are IP-addressable host devices equipped for sending and receiving IP datagrams (or packets) with other host devices in the wireless communication system 100.

The mobile nodes 108-111 communicate with the sites 101-106 via RF resources 112. The RF resources 112 may comprise, for example, narrow band frequency modulated channels, wideband modulated signals, broadband modulated signals, time division modulated slots, carrier frequencies, frequency pairs, or generally any medium for communicating payload or control information to and from the sites 101-106. The sites 101-106 include antennas 114 and base radios (“BRs”) 116 (sometimes called base stations) for transceiving the payload or control information with the mobile nodes.

Although not shown in FIG. 1, the mobile nodes include respective memory and processors, such as microprocessors, microcontrollers, digital signal processors or combinations of such devices for storing and executing software routines, respectively, within the mobile nodes. The processing functionality residing within the base radios and mobile nodes that perform physical layer processing is known as “layer 1” processing. The processing functionality that supports over-the-air (e.g., RF) communications is known in the art as “layer 2” functionality. Higher level processing functions, for example, forming or interpreting IP packets or mobile IP packets, are known as “layer 3” functions. The aggregate of these layers is often referred to as a “stack.”

Each site 101-106 has its own foreign agent 118 (denoted FA1 through FA6). The foreign agents 118 comprise hosts or routers that are adapted to provide foreign agent services to visiting mobile node(s) generally according to standard mobile IP protocol except the foreign agents do not receive solicitation messages or send advertisement messages, as will be described in relation to FIG. 3. As shown, foreign agents FA1, FA2, FA4, FA5 provide such foreign agent services for MN1, MN2, MN3 and MN4, respectively.

As will be appreciated, the sites 101-106 may also include infrastructure devices including, but not limited to, dispatch console(s), call logger(s), gatekeeper(s), web server(s), video server(s), game server(s), IP gateway(s), comparator(s), telephone interconnect device(s), internet protocol telephony device(s) or scanner(s). These devices are typically wireline devices, i.e., connected by wireline to the base site(s) or other infrastructure device(s) but may also be implemented as wireless devices.

The antennas 114, base radios 116 and foreign agents 118 (along with any other infrastructure devices at the sites) are connected by links 120 to respective site routers 122 (six shown, denoted “Site Router 1” through “Site Router 6”). The links 120 are logical links that may be physically realized by wireline (e.g., Ethernet local area network (LAN)) or wireless (e.g., Bluetooth) links. The sites 101-106 are logically coupled, via the site routers 122 to one or more “core routers” 126 (two shown, denoted “Core Router 1” and “Core Router 2”). The site routers and core routers are logically connected via packet network (e.g., WAN) links including intra-zone links 124 and inter-zone links 134. The inter-zone links are logically connected via an IP network 136. The core routers 126 are connected to various IP-addressable hosts including, as shown, zone controllers 128, home agents 130 (termed “HA1” and “HA2”) and fixed correspondent nodes 132 (termed “End Host 1” and “End Host 2”). As will be appreciated, the site routers, core routers, zone controllers and home agents are functional elements that may be embodied in separate physical devices or combinations of such devices.

Generally, the site routers 122 and core routers 126 comprise specialized or general purpose computing devices configured to receive IP packets from a particular host in the communication system 100 and relay the packets to other router(s) or host(s) in the communication system 100. Packets are distributed between hosts from point-to-point using IP unicast routing protocols or from point-to-multipoint (i.e., to groups of hosts) using IP multicast routing protocols.

The zone controllers 128 perform call processing and mobility management functions for mobile nodes within their respective zones, as is known in the art.

The home agents 130 are router elements that receive the current care of address of mobile nodes from foreign agents associated with the visited site and, responsive to receiving packets destined to the mobile node's home address, encapsulate and tunnel the packets to the mobile node's registered care of address. For purposes of the present example, HA1 is the home agent of each of the mobile nodes 108-111.

The correspondent nodes 132 comprise peer nodes with which the mobile nodes 108-111 may communicate. The correspondent nodes 132 may be fixed (as shown) or mobile nodes. The correspondent nodes 132 generally know the home address of the mobile nodes 108-111 but not their care of address. The home agents 130 are also correspondent nodes (i.e., in the sense that they may communicate with the mobile nodes) although they are a special case of correspondent node that knows the home address and care of address of the mobile nodes and is adapted to tunnel packets to the mobile nodes using the care of address as described herein.

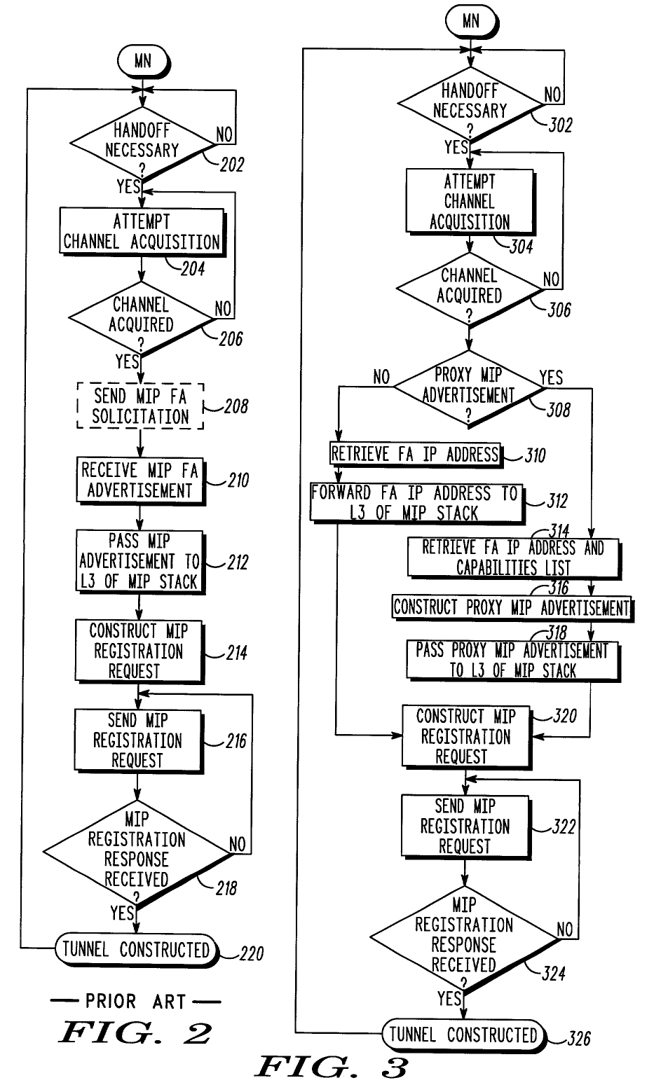

According to principles of the present invention, the mobile nodes 108-111 are operable to perform mobile IP registration without exchanging solicitation/advertisement messages with a foreign agent. This is perhaps best observed by comparing FIG. 2, showing steps performed by a mobile node to perform mobile IP registration according to the prior art, and FIG. 3, showing steps performed by a mobile node to perform mobile IP registration according to a preferred embodiment of the present invention. The steps of FIG. 2 and FIG. 3 are implemented, where applicable, using stored software routines within the mobile nodes 108-111.

Turning initially to FIG. 2, mobile IP registration according to the prior art begins at step 202 when the mobile node detects that a handoff is necessary to a foreign site or network. Methods for determining whether and when handoff is necessary from an existing site or network to a new site or network are well known in the art. Generally, handoffs are necessary whenever the mobile node roams to a new site and/or zone away from its home network, for which it has not yet identified a foreign agent or obtained a care of address. “Handoffs” are also needed when a mobile node first powers up at a particular site or network for which it is has not yet identified a foreign agent or obtained a care of address. In the case of wireless mobile nodes (e.g., mobile nodes 108-111), the mobile nodes are always presumed to be away from home and hence always require a foreign agent and care of address. For example, with reference to FIG. 1, each of mobile nodes MN1 through MN4, upon first roaming to or powering up at respective sites 101, 102, 104, 105, must perform mobile IP registration to identify their respective foreign agents and obtain their respective care of addresses.

If handoff is necessary, the mobile node at step 204 attempts to acquire a communication channel (e.g., RF channel) associated with the new site or network. The communication channel may be a designated control channel or payload channel, or combined control and payload channel sourced from a base radio 116 of the new site or network. In the process of attempting to acquire the channel (or after acquiring the channel) the mobile node receives control information associated with the new site, as is known in the art. The control information may comprise, for example, information indicating the availability of the channel to support requested service(s). It is important to note, such control information heretofore did not include the IP address of the foreign agent or otherwise any information that would enable the mobile node to identify the foreign agent or obtain a care of address. That information would only be provided in conjunction with solicitation/advertisement messages, as will be described in relation to steps 208 and 210.

At step 206, the mobile node determines whether a channel has been acquired. If not, the process returns to step 204 to re-attempt acquisition of channel(s), as may be appropriate, until an acceptable channel is acquired. Once a channel is acquired, the mobile node sends at step 208 a mobile IP solicitation message over the air to solicit a response from a foreign agent of the new site. The foreign agent responds with a mobile IP advertisement, which is received by the mobile node at step 210. Historically, the mobile IP advertisement included a capabilities list associated with the foreign agent and an IP address of the foreign agent.

At step 212, the mobile node passes the mobile IP advertisement message to layer 3 of its mobile IP stack. That is, the mobile IP advertisement is passed, unmodified, to function(s) of the mobile node having the ability to receive and process the mobile IP advertisement message. According to the prior art, layer 3 interpretation of the mobile IP advertisement is the first opportunity for the mobile node to identify the capabilities and IP address of the foreign agent of the visited site. Upon interpreting the mobile IP advertisement to identify the capabilities and IP address of the foreign agent, the mobile node at step 214 constructs a mobile IP registration request. According to standard mobile IP protocol, the destination address of the mobile IP registration request comprises the IP address of the visited foreign agent.

The mobile node sends the mobile IP registration request to the foreign agent at step 216. At step 218, the mobile node determines whether it has received a response (e.g., acknowledgment) to the registration request. If the mobile node has not received a response, it re-sends the mobile IP registration request at step 216 until such time it has received a response. Upon having received a response, the mobile node determines at step 220 that a tunnel is (or will be) constructed by the foreign agent forwarding the mobile IP registration request to the mobile node's home agent and providing a care of address to which the home agent may send packets to the mobile node while it is at the visited site. The entire process is repeated to identify new foreign agent(s), etc. any time the mobile node roams to a new site or zone and determines that handoff(s) are necessary.

Now turning to FIG. 3, mobile IP registration according to the preferred embodiment of the present invention begins at step 302 (in similar fashion as step 202, FIG. 2), when the mobile node detects that a handoff is necessary to a foreign site or network. If handoff is necessary, the mobile node at step 304 attempts to acquire a communication channel (e.g., RF channel) associated with the new site or network. The communication channel may be a designated control channel or payload channel, or combined control and payload channel sourced from a base radio 116 of the new site or network. In the process of attempting to acquire the channel (or after acquiring the channel) the mobile node receives control information associated with the new site. The control information may comprise, for example, information indicating the availability of the channel to support requested service(s).

In the preferred embodiment, the control information received at step 304 (unlike that received at step 204, FIG. 2) also includes the IP address of the foreign agent of the visited site. The foreign agent IP address is thereby communicated to mobile node(s) via an unsolicited layer 2 broadcast message. The mobile node stores the foreign agent IP address in memory such that it may be retrieved later and passed to a layer 3 processing element, or used to construct a proxy mobile IP advertisement that is passed to the layer 3 processing element, as will be described. In one embodiment, the mobile node also stores static capabilities list(s) associated with different foreign agents. In such manner, the foreign agent IP address and static capabilities list associated with the visited foreign agent is known by the mobile node without the need for sending solicitation message(s) to the foreign agent or receiving advertisement message(s) from the foreign agent.

The static capabilities list(s) may comprise programming instructions that are programmed into the mobile node at time of manufacture, periodic maintenance, and so forth, indicating capabilities of certain foreign agent(s). Alternatively, the static capabilities list may be provided over-the-air coincident to receiving control information at a new site, as is the case with the foreign agent IP address. In one embodiment, the static capabilities list is received prior to, or coincident to, the IP address of the foreign agent but in any case, the static capabilities list is known by the mobile node independent of any advertisement messages sent by a foreign agent.

At step 306, the mobile node determines whether a channel has been acquired. If not, the process returns to step 304 to re-attempt acquisition of channel(s), as may be appropriate, until an acceptable channel is acquired. Once a channel is acquired, the mobile node may take either of two alternative courses of action, depending on whether or not a proxy mobile IP advertisement will be used (determined at step 308). In one embodiment, the determination at step 308 is pre-programmed into the mobile node. That is, the mobile node either is programmed to proxy a mobile IP advertisement, or not, depending on operating parameters of the communication system 100. As with the static capabilities list, the programming instructions instructing the mobile node whether or not to use a proxy mobile IP advertisement may be programmed into the mobile node at time of manufacture, periodic maintenance, and so forth, or may be provided over-the-air coincident to receiving control information at a new site.

In response to a negative determination at step 308 (i.e., no proxy MIP advertisement), the mobile node retrieves at step 310 the foreign agent IP address and forwards the foreign agent IP address at step 312 to layer 3 of its mobile IP stack. At step 320, the layer 3 function of the mobile node constructs a mobile IP registration request targeted to the visited foreign agent's IP address. The registration request is constructed using the foreign agent IP address received prior to acquiring a communication channel at the new site, thereby eliminating the need for the mobile IP solicitation/advertisement message transaction(s) used in the prior art. By eliminating solicitation/advertisement messages, mobile IP registration may be accomplished substantially immediately after the mobile node finds an acceptable channel (i.e., within tenths of seconds) at the new site or zone, hence tunnel construction may be accomplished at nearly the same speed as cell handoff.

In response to a positive determination at step 308, the mobile node retrieves at step 314 the foreign agent IP address and static capabilities list and, based on the capabilities list, constructs a proxy mobile IP advertisement at step 316. At step 318, the proxy mobile IP advertisement is forwarded by the mobile node to layer 3 of its mobile IP stack. At step 320, the layer 3 function of the mobile node constructs a mobile IP registration request targeted to the visited foreign agent's IP address, as has been described.

Having constructed the mobile IP registration request, the mobile node sends the mobile IP registration request to the foreign agent at step 322. At step 324, the mobile node determines whether it has received a response (e.g., acknowledgment) to the registration request. If the mobile node has not received a response, it re-sends the mobile IP registration request at step 322 until such time it has received a response. Upon having received a response, the mobile node determines at step 326 that a tunnel is (or will be) constructed by the foreign agent forwarding the mobile IP registration request to the mobile node's home agent and providing a care of address to which the home agent may send packets to the mobile node while it is at the visited site. The foreign agent performs a mapping function between the mobile node IP address and the correct base station IP address, such that when the foreign agent receives packets tunneled from the home agent, it knows which base station to send packets destined for the mobile node. The base station receives the IP packets through its local application and transmits the packet to the mobile node. The entire process is repeated to identify new foreign agent(s), etc. any time the mobile node roams to a new site or zone and determines that handoff(s) are necessary.

The present disclosure has identified mobile IP registration solutions for mobile nodes that provides for seamless mobility across both wired and wireless infrastructures. A mobile node receives a foreign agent IP address via unsolicited control message(s) upon roaming into a new site or zone, thus eliminating the need to exchange traditional solicitation/advertisement messages with foreign agents. The mobile nodes construct mobile IP registration requests using the foreign agent IP address and/or a static capabilities list retrieved from memory. Unsolicited broadcast of the foreign agent IP address allows for movement detection and tunnel construction at nearly the same speed as cell handoff (roaming).

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a communication system supporting mobile IP wherein a mobile node roaming to a foreign site performs mobile IP registration with a foreign agent, a method for the mobile node to perform the mobile IP registration without relying on a mobile IP advertisement from the foreign agent, the method comprising the mobile node performing steps of:
obtaining, without solicitation, an IP address of the foreign agent;
substantially immediately upon acquiring a channel at the foreign site,
retrieving the foreign agent IP address;
retrieving a static capabilities list associated with the foreign agent;
forwarding the foreign agent IP address and static capabilities list to a processing element of the mobile node operable to construct a mobile IP registration request; and
constructing, by the processing element, a mobile IP registration request addressed to the foreign agent IP address.

2. The method of claim 1, wherein the step of obtaining the foreign agent IP address is accomplished by the mobile node receiving control information from the foreign site prior to acquiring a payload channel at the foreign site.

3. The method of claim 2, wherein the step of obtaining the foreign agent IP address is accomplished by the mobile node receiving control information from the foreign site when attempting acquisition of a payload channel at the foreign site.

4. The method of claim 1, wherein the processing element comprises a layer 3 processing element of the mobile node, the step of forwarding the foreign agent IP address thereby comprising forwarding the foreign agent IP address to the layer 3 processing element.

5. The method of claim 4, wherein the step of forwarding the foreign agent IP address to the layer 3 processing element is accomplished by a layer 2 processing element of the mobile node.

6. The method of claim 1, wherein the step of obtaining an IP address comprises selecting an IP address from plurality of foreign agent IP addresses stored in memory; and the step of retrieving a static capabilities list comprises selecting a static capabilities list from a plurality of foreign agent static capabilities lists stored in memory.

7. In a communication system supporting mobile IP wherein a mobile node roaming to a foreign site performs mobile IP registration with a foreign agent, a method for the mobile node to perform the mobile IP registration without relying on a mobile IP advertisement from the foreign agent, the method comprising the mobile node performing steps of:
obtaining, without solicitation, an IP address and capabilities list of the foreign agent;
substantially immediately upon acquiring a channel at the foreign site,
retrieving the foreign agent IP address and capabilities list;
constructing a proxy mobile IP advertisement;
forwarding the proxy mobile IP advertisement to a processing element of the mobile node operable to construct a mobile IP registration request; and
constructing, by the processing element, a mobile IP registration request addressed to the foreign agent IP address.

8. The method of claim 7, wherein the step of obtaining the foreign agent IP address is accomplished by the mobile node receiving control information from the foreign site prior to acquiring a payload channel at the foreign site.

9. The method of claim 8, wherein the step of obtaining the foreign agent IP address is accomplished by the mobile node receiving control information from the foreign site when attempting acquisition of a payload channel at the foreign site.

10. The method of claim 7, wherein the step of obtaining the foreign agent capabilities list comprises storing a static foreign agent capabilities list in a memory of the mobile node.

11. The method of claim 7, wherein the step of obtaining the foreign agent capabilities list is accomplished by the mobile node receiving control information from the foreign site prior to acquiring a payload channel at the foreign site.

12. The method of claim 11, wherein the step of obtaining the foreign agent capabilities list is accomplished by the mobile node receiving control information from the foreign site when attempting acquisition of a payload channel at the foreign site.

13. The method of claim 7, wherein the processing element comprises a layer 3 processing element of the mobile node, the step of forwarding the proxy mobile IP advertisement thereby comprising forwarding the proxy mobile IP advertisement to the layer 3 processing element.

14. The method of claim 13, wherein the step of forwarding the proxy mobile IP advertisement to the layer 3 processing element is accomplished by a layer 2 processing element of the mobile node.

15. In a communication system supporting mobile IP wherein a mobile node roaming to a foreign site performs mobile IP registration with a foreign agent, a method for the mobile node to perform the mobile IP registration without relying on a mobile IP advertisement from the foreign agent, the method comprising:
obtaining, by the mobile node, without solicitation, an IP address of the foreign agent;
substantially immediately upon acquiring a channel at the foreign site,
retrieving, by the mobile node, the foreign agent IP address;
forwarding, by the mobile node, the foreign agent IP address to a processing element operable to construct a mobile IP registration request;
retrieving, by the processing element, a static capabilities list associated with the foreign agent; and
constructing, by the processing element, a mobile IP registration request addressed to the foreign agent IP address.

16. The method of claim 15, wherein the step of obtaining an IP address comprises selecting an IP address from plurality of foreign agent IP addresses stored in memory; and the step of retrieving a static capabilities list comprises selecting a static capabilities list from a plurality of foreign agent static capabilities lists stored in memory.

17. The method of claim 15, wherein the step of obtaining the foreign agent IP address is accomplished by the mobile node receiving control information from the foreign site prior to acquiring a payload channel at the foreign site.

18. The method of claim 17, wherein the step of obtaining the foreign agent IP address is accomplished by the mobile node receiving control information from the foreign site when attempting acquisition of a payload channel at the foreign site.

19. The method of claim 15, wherein the processing element comprises a layer 3 processing element of the mobile node, the step of forwarding the foreign agent IP address thereby comprising forwarding the foreign agent IP address to the layer 3 processing element.

20. The method of claim 19, wherein the step of forwarding the foreign agent IP address to the layer 3 processing element is accomplished by a layer 2 processing element of the mobile node.
